(19) United States
(12) Patent Application Publication
(10) Pub. No.: US 2005/0146463 A1
(43) Pub. Date: Jul. 7, 2005

(54) Method and apparatus for beam steering in a wireless communications system

(76) Inventors: Calin Moldoveanu, Thornhill (CA); Octavian V Sarca, Toronto (CA); Radu Selea, North York (CA)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/489,635

(22) PCT Filed: Sep. 12, 2002
(86) PCT No.: PCT/CA02/01391

Related U.S. Application Data
(60) Provisional application No. 60/318,680, filed on Sep. 13, 2001.

(51) Int. Cl. H01Q 3/26

(52) U.S. Cl. 342/368; 342/354; 455/129

(57) ABSTRACT

A method and apparatus is provided that allows M transceivers to transmit/receive using M2^{N} distinct beams using passive beam steering. This provides for the use of arbitrary narrow beams with a number of transceivers that is a fraction of the number of beams but ensures 360° coverage. In other words it permits significant improvements in the link budget with a minimal rise in the cost of the BS. The apparatus includes M distribution switches applied to 2^{N} passive beam forming networks each coupled to M antennas. The method and apparatus are compatible with TDM in the downlink and TDMA in the uplink.

### FIELD OF THE INVENTION

The present invention relates to wireless communications systems and is particularly concerned with beam steering.

### BACKGROUND OF THE INVENTION

An essential part of any wireless link is the design of the antenna and the choice of its beam width (or angle) and its gain. In general antennas with narrower beam provide higher gains.

The gain of the antenna contributes twice in the link budget: both at transmission and at reception. At transmission, the effective incident radiated power (EIRP) [dBm] is the sum between the antenna gain G_{T} [dBi] and the transmitter power P [dBm].
EIRP[dBm]=P[dBm]+G_{T}[dBi]

At reception, the signal level S[dBm] at input of the receiver is the sum between the antenna gain G_{R} and the transmitted EIRP minus the path loss PL [dBi].
S[dBm]=G_{R}[dBi]+EIRP[dBm]−PL[dBi]

The link budget and consequently the coverage can be improved by raising the transmitter power P or by raising the antenna gains G_{T} or G_{R}. For a transceiver that use the same antenna to transmit and receive, i.e. G_{T}=G_{R}, increasing the antenna gain has positive effects on both transmission and reception while increasing the power improves only the transmission. For symmetric links (all participant systems have the same P and G_{T}=G_{R}), increasing the antenna gain has double effect than increasing the transmitter power P.

The EIRP in each frequency band is usual limited by regulatory bodies like Federal Communications Commission in USA. In such cases, the only way to improve the link budget and the coverage is to raise the gain of the antenna at the receiver G_{R}.

When EIRP is limited, rising the antenna gain at the transmitter G_{T} has to be associated with a corresponding reduction in the power of the transmitter P and implicitly a reduction in the cost of the power amplifier (PA).

Antennas with narrower beams provide more spatial selectivity, which in turn, improves the system immunity to interference.

With current technologies, the advantages of using high-gain, narrow-beam antennas are offset in the design of a base-station (BS) by the price of the transceivers needed to obtain 360° coverage. For example, a 23 dBi pencil-beam (same beam width in the vertical and horizontal plane) antenna will have a beam with of only 14°. Thus, in order to ensure 360° coverage with current technologies, we would need 26 antennas and consequently 26 transceivers.

It is known in wireless systems to use beam forming to emulate a high gain antenna using multiple low-gain antennas. This is achieved using a system as depicted in FIG. 1. A wireless system 10 includes a transceiver 12 coupled to a phase-delay passive network 14 coupled to a plurality of antennas 16 as in the system of FIG. 1. A phase-delay network is inserted between the transceiver and the antennas.

In operation, at transmission, the phase-delay network 10 distributes the signal from the transceiver 12 to all antennas 16. At reception the network combines the signal received from all antennas 16 and passes the resulting signal to the transceiver 12. The phase and delay for each antenna are established in accordance with the position of the antennas such that the desired beam width and direction are obtained.

An extension of the passive beam forming uses several transceivers 12 with multiple-input phase-delay network. It has been shown that such a network can be implemented and produces beams With gain higher than of the constituent antennas if:
1. The number of transceivers does not exceed the number of antennas.
2. The transceivers operate on close but different frequencies to avoid cross-talk between beams.

Referring to FIG. 2, there is illustrated a known wireless system for active beam steering. The wireless system 20 includes a transceiver common part 22 coupled to an electronically controlled phase delay active network 24 coupled to a plurality of transceiver RF parts 26 each coupled to a corresponding one of a plurality of antennas 28.

Active beam steering is another extension of beam forming, in which the phase-delay network is electronically controlled. By trimming phases and delays, the resulting beam can be steered into the desired direction.

Both known beam forming of FIG. 1 and steering of FIG. 2 require precise amplitude, phase and delay control in the phase-delay network. They also require precise alignment of the antennas and precise amplitude, phase and delay matching between RF cables. In practical systems, the precision of these elements is the most important factor that limits the achievable antenna gain. Precision is especially hard to maintain with beam steering where phase and delay parameters are variable. Practical implementations of beam steering use phase-delay networks implemented in base-band processors to ensure precise delay and phase control. Therefore in active beam steering systems the RF part of the transceiver is replicated for each antenna, as shown in FIG. 2.

Active beam steering systems are very expensive because they require replication of the RF subunit for each antenna when multiple antennas are used to achieve a single beam.

Even with the phase-delay network implemented in base-band, the active beam-steering systems require precise amplitude, phase and delay matching between RF subunits. In practice, errors occur and this seriously limits the maximum achievable antenna gain.

A further concern is that the active beam steering system of FIG. 2 offers no upgrade path, an important feature in wireless system deployment. In order to add a second beam, one must add an entire new system with multiple RF subunits and multiple antennas in addition to the new transceiver. This could be an important limitation during wireless system deployment.

Active beam steering may not be compatible with current standards for wireless broadband access. In FIG. 3, an example of an air interface for a wireless system illustrated in a functional block diagram. The air interface 30 includes a downlink portion 32 and an uplink portion 34. The downlink portion begins with a broadcast segment 36 followed by a plurality of unicast segments 38. The uplink portion 34 includes a contention window 40 and a plurality of scheduled uplinks 42.

As shown in FIG. 3, these standards, e.g. IEEE802.16, employ downlink broadcast messages that must be sent from the base-station (BS) to all subscriber stations (SS) at the same time. They also employ uplink contention windows during which BS has to “listen” for new SSs without knowing the direction in which it must steer the beam. In order to support these features, the beam must be made 360° wide during these periods. This may not be acceptable or even possible because, for example, enlarging the beam from 22° to 360° causes a reduction of the antenna gain of at least 12 dB.

### SUMMARY OF THE INVENTION

Accordingly the present invention provides a method and apparatus that allows M transceivers to transmit/receive using M2^{N} distinct beams using passive beam steering.

Advantages of the present invention allows use of arbitrary narrow beams with a number of transceivers that is a fraction of the number of beams but ensures 360° coverage. In other words it permits significant improvements in the link budget with a minimal rise in the cost of the BS.

Advantages of the present invention entails a method which does not require precise positioning of the antennas and does not require amplitude, phase or delay matching in the RF cabling.

Advantages of the present invention entails a method that requires replication of only a small part of the RF stages but it does not require amplitude, phase or delay matching between them.

Advantages of the present invention entails a method and apparatus which allow easy, hot upgrade from M to M+1, M+2 and so on up to M2^{N} transceivers.

Advantages of the present invention entail a method and apparatus which allow hot downgrade from any number of transceivers grater than M+1 down to M transceivers. It is shown that downgrade paths can be used to provide a fail-safe system.

Advantages of the present invention include both the upgrades and the downgrades are performed without affecting the antenna or the beam gain as seen by each subscriber station. In other words upgrades and downgrades are performed without affecting the RF link budget.

Advantages of the present invention entail a method and apparatus which are described as applied at RF but it can also be seamlessly applied at IF or base-band. However the cost of the system is minimized when invention is applied at RF.

Advantages of the present invention entail a method as shown to be compatible with existing wireless broadband access standards. It is shown that it supports broadcast messages in the downlink and contention windows in the uplink without changing the antenna gain and the link budget.

### BRIEF DESCRIPTION OF THE DRAWINGS

These and other features of the invention will become more apparent from the following description in which reference is made to the appended drawings.

FIG. 1 illustrates a known wireless system with passive beam forming;

FIG. 2 illustrates a known wireless system with active beam steering;

FIG. 3 illustrates in a block diagram an air interface for a wireless communications system;

FIG. 4. illustrates a wireless system in accordance with an embodiment of the present invention;

FIGS. 5a and 5b illustrate examples of grouping for M2^{N}=16 for the system of FIG. 4;

FIG. 6 illustrates in further detail a 4-way distribution switch for the system of FIG. 4;

FIG. 7 illustrates all useful configurations that can be obtained with the 4-way distribution switch of FIG. 6;

FIG. 8 there is illustrated an 8-way distribution switch for the system of FIG. 4;

FIG. 9 illustrates upgrade-downgrade paths with the 8-way distribution switch of FIG. 8;

FIG. 10 illustrates a possible implementation of the cross-switch of FIGS. 6 and 8;

FIG. 11 illustrates a possible implementation of the straight-switch FIGS. 6 and 8;

FIG. 12 illustrates in a block diagram a protocol for one MAC frame for TDM/TDMA access to 2ⁿ beams;

FIG. 13, there is illustrated in a flow chart a beam selection in accordance with an embodiment of the present invention; and

FIG. 14 illustrates in a block diagram an alternative protocol for one MAC frame for TDM/TDMA access to 2ⁿ beams.

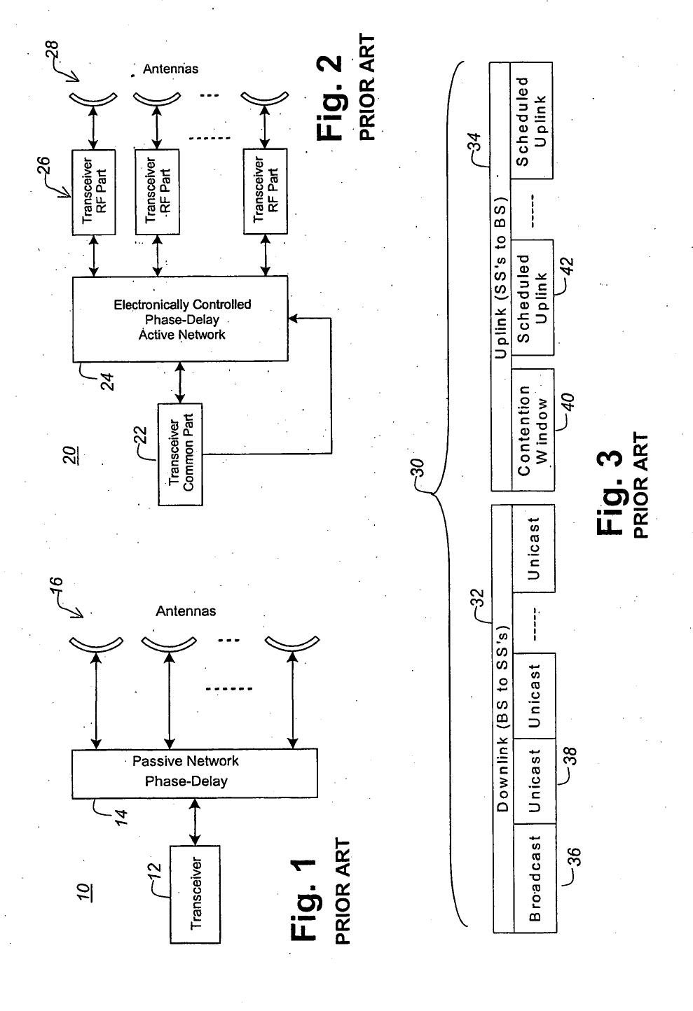

### DETAILED DESCRIPTION OF THE PREFERRED EMBODIMENT

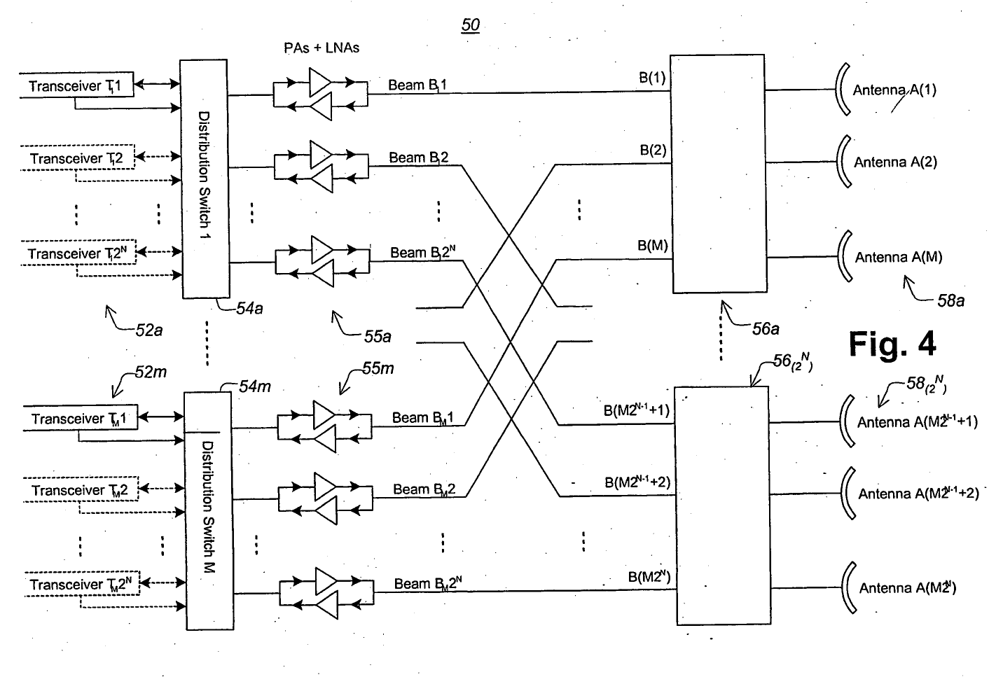

Referring to FIG. 4. there is illustrated a wireless system in accordance with an embodiment of the present invention. The wireless system 50 includes a plurality of transceivers 52a-m coupled to a corresponding plurality of distribution switches 54a-m. Distribution switches 54a-m each having 2ⁿ outputs for coupling to corresponding inputs of 2ⁿ passive beam forming networks 56 each passive beam-forming network 56 is connected to a plurality M of antennas 58.

The system of FIG. 4 uses M2^{N} high-gain antennas 58 that are first grouped in 2^{N} groups of M antennas each. Each group of M antennas is processed by one beam-forming network 56 to form M high-gain beams. Note, that an embodiment of the invention may be applied without the beam-forming network, in which the beam width and gain are equal to the antenna angle and gain. However, in most cases when a large number of antennas are used the beam-forming network will be used to reduce significantly the cost of the antenna system.

In operation, the resulting M2^{N} beams operate on M different frequencies to ensure proper operation of the beam-forming network.

Each group of 2^{N} beams operating on the same frequency is processed through a distribution switch 54 that allows 1, 2, 3, and up to 2^{N} transceivers 52 to control the 2^{N} beams.

The present passive beam steering permits a top-down approach to the design of an upgradeable BS. The designer chooses the beam angle (width) BA based on the performance of the beam forming technology and the antenna availability. The designer chooses also the minimum separation angle SA between active beams operating at the same frequency and the minimum overlapping angle OA between adjacent beams. Then, 360°/(BA−OA) gives the minimum number of sectors needed in the system and 360°/(BA+SA) gives the maximum frequency reuse in the system. The designer chooses M and N such that:
M2^{N}≧360°/(BA−OA) and 2^{N}≦360°/(BA+SA)

The antenna system provides M2^{N} beams circularly placed at angles of 360°/M2^{N} one to each other. The beams will be divided into M groups: G1, G2, . . . , GM, each having 2^{N} beams. If beams are numbered in circular order from 1 to M2^{N}, then G1 will contain beams B11=1, B12=M+1, B13=2M+1, . . . , while G2 will contain beams B21=2, B22=M+2, B23=2M+2, . . . , etc. Each group of antennas will operate on the same frequency and different groups will operate on different frequencies.

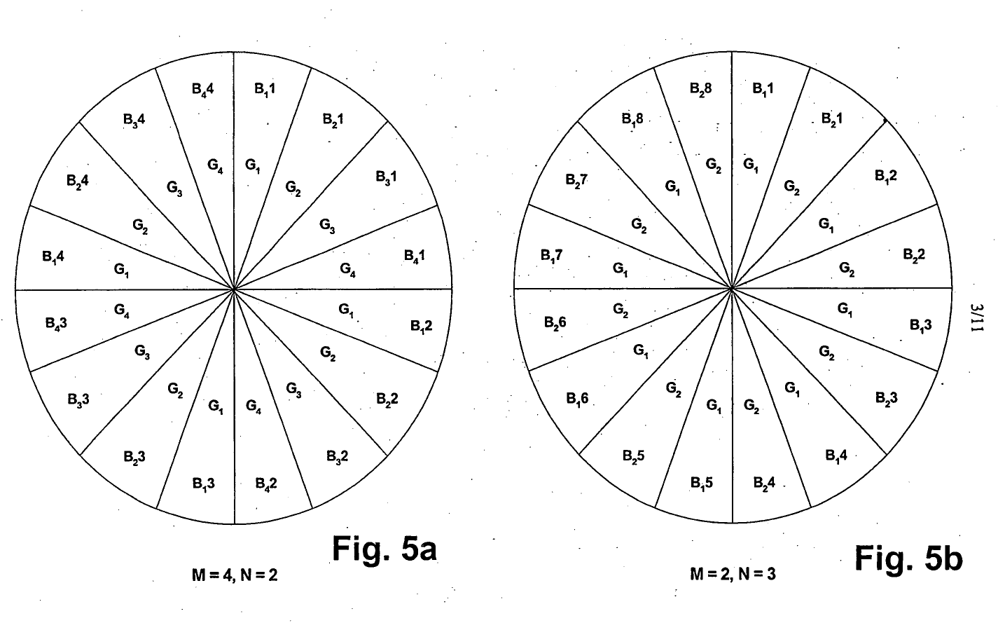

Referring to FIG. 5a and 5b there are illustration examples of grouping for M2^{N}=16. Note that M=8, N=1 and M=16, N=0 are also possible solutions. FIG. 5a shows M=4, N=2 and FIG. 5b shows M=2, N=3. Each group of beams is processed by one distribution switch 54 that allows 1, 2, . . . , or 2^{N} transceivers 52 to cover all subscriber-stations in all 2^{N} beams. This is achieved using time-division-multiple-access (TDMA).

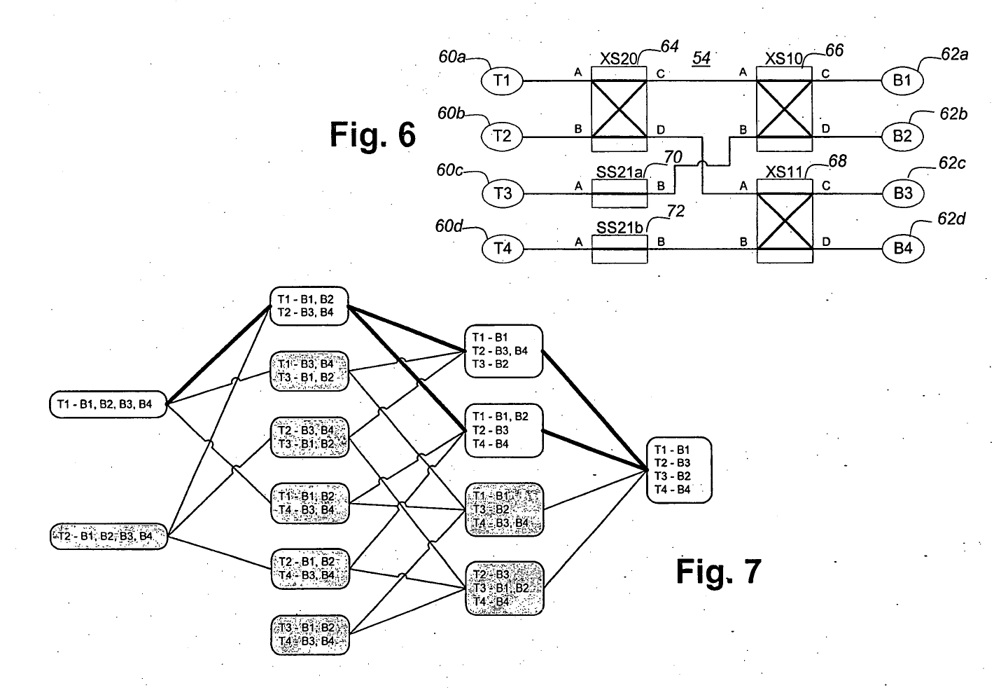

Referring to FIG. 6, there is illustrated in further detail the distribution switch of FIG. 4. The four way distribution switch 54 includes a plurality of inputs 60a-60d for coupling to corresponding transmitters T1-T4 and a plurality of outputs 62a-62d for coupling to corresponding beams B1-B4. The four way distribution switch 54 includes first and second cross connect switches 64 and 66 coupled in series between inputs 60a and 60b and outputs 62a and 62b. A third cross connect switch 68 coupled to outputs 62c and 62d having a first input coupled to a second output of cross connect switch 64. The cross connect switch 64 also includes straight switches 70 and 72. Straight switch 70 coupled to input 60c and 72 coupled to input 60d. Straight switch 70 having an output coupled to a second input of cross switch. 66 and straight switch 72 having an output coupled to a second input of cross switch 68.

The distribution switch is important because it connects one group of 2^{N} beams to one transceiver or 2 transceivers or so on up to 2^{N} transceivers. To understand its operation we use an example for N=2, then we show how it can be extend to N=3, 4, etc.

FIG. 6 shows the structure of the 4-way distribution switch (i.e. N=2). It connects 4 beams B1, B2, B3 and B4 to one, two, three or four transceivers: T1, T2, T3, T4. The distribution switch is built with 3 cross-switches: XS20, XS10 and XS11, and two straight switches SS21a and SS21b.

The cross switches can be configured in four modes:
1. Straight: port A connects port C and port B connects port D, both with 3 dB insertion loss
2. Cross: port A connects port D and port B connects port C, both with 3 dB insertion loss
3. A-only: port A is split/combined to ports C and D
4. B-only: port B is split/combined to ports C and D

As described below, the cross-switch at IF or RF is implemented using switches and 3 dB splitters/combiners; thus, it introduces 3 dB insertion loss plus losses due to imperfections. The straight-switches must introduce 3 dB insertion loss in order to balance the insertion loss of the cross-switches. The straight switches can be used to introduce additional isolation when either T3 or T4 are not in use or they can be simple 3 dB attenuators connecting port A with port B. More details can be found below, where the construction of these switches is described.

When deploying the system, the service provider will likely decide that a single transceiver is enough to cover all four beams. The transceiver is connected to T1 and the BS controller instructs the distribution switch that T1 can manipulate all cross switches. Therefore, T1 covers all four beams: B1, B2, B3 and B4 using the following configurations:

TABLE A
One transceiver over 4 beams configurations

| Configuration | | | | |
|---|---|---|---|---|
| XS20 | XS10 | XS11 | Mode | Description |
| Straight | Straight | — | Tx or | T1 transmits/receives |
| | | | Rx | through B1 |
| Straight | Cross | — | Tx or | T1 transmits/receives |
| | | | Rx | through B2 |
| Cross | — | Straight | Tx or | T1 transmits/receives |
| | | | Rx | through B3 |
| Straight | — | Cross | Tx or | T1 transmits/receives |
| | | | Rx | through B4 |
| A-only | A-only | A-only | Tx | T1 transmits on B1, B2, B3, B4 |
| | | | | (downlink broadcasts) |
| A-only | A-only | A-only | Rx | T1 receives from B1, B2, B3, B4 |
| | | | | (uplink contention windows) |
| Straight | A-only | — | Rx | T1 receives from B1, B2 |
| | | | | (BSA - see below) |
| Cross | — | A-only | Rx | T1 receives from B3, B4 |
| | | | | (BSA - see below) |

When the service provider (SP) determines that the single transceiver 52a₁ is overloaded, i.e. the data bandwidth provided by one transceiver is not enough, the SP can upgrade the system to two transceivers. The second transceiver 52a₂ is added to port T2 without interfering with the operation of the existing transceiver 52a₁. The BS controller configures XS20 (64) as straight (A connects C and B connects D) and instructs the distribution switch 54a to allow T1 (60a) to control XS10 (66) and T2 (60b) to control XS11 (68). Therefore, T1 (60a) covers two beams: B1 and B2, and T2 (60b) covers the other two beams: B3 and B4.

Depending on the service growth, the service provider may need to further upgrade the system. If T1 (60a) is overloaded, a third transceiver 52a₃ can be added at port T3 (60c); the BS controller configures XS10 (66) as straight and will leave T2 (60b) to control XS11 (68) (XS20(64) was already configured straight); T1(60a) covers beam B1, T3 (60a) covers B2, and T2(60b) covers B3 and B4. If T2(60b) is overloaded, a transceiver can be added at port T4(60d); the BS controller configures XS11(68) as straight and leaves T1(60a) to control XS10(66); T1(60a) covers B1 and B2, T2(60b) covers B3, and T4(60d) covers B4. Finally, if all four transceivers are used, the BS controller configures all 3 cross switches (64,66,68) as straight and does not let any transceiver to control any cross switch. Then, T1(60a) covers B1, T2(60b) covers B3, T3(60c) covers B2 and T4(60d) covers B4.

The same paths used to upgrade to more transceivers can also be used to downgrade to fewer transceivers. The distribution switch 54 offers many other configurations that can be used for making the system 50 fail safe.

Referring to FIG. 7 there is illustrated all useful configurations that can be obtained with the 4-way distribution switch. The five white blocks show the configurations discussed above, i.e. the upgrade-downgrade paths. The shaded configurations are not recommended for upgrade/downgrade; which provides the same functionality as the white, non-shaded configurations there is less upgrade/downgrade flexibility. However, shaded configurations can be used to provide back-off possibilities in the event that one or more transceivers fail. With two or more transceivers installed in the system, if any of the transceivers fails, the distribution switch can always be reconfigured such that the remaining transceivers cover all beams. When all transceivers are installed, the system becomes immune to failure of any two transceivers.

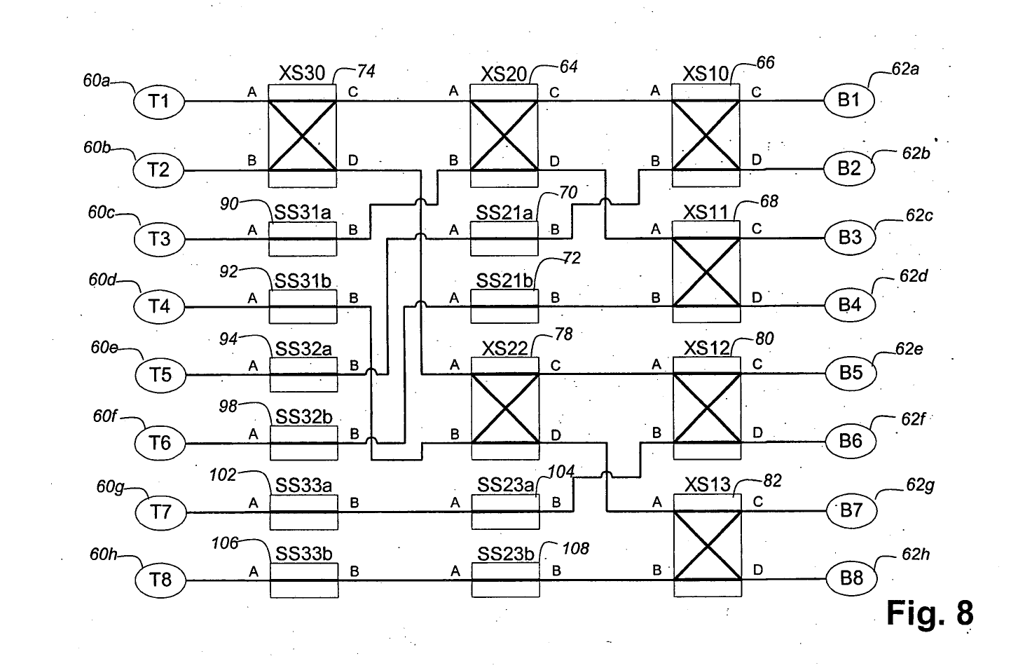

Referring to FIG. 8 there is illustrated an 8-way distribution switch (N=3). The 8-way switch includes eight inputs 60a, . . . 60i for transceivers T1, . . . T8 and eight outputs 62a, . . . 62i for beams B1, . . . B8. Between inputs 60a and 60b and outputs 62a and 62b are three cross switches 70, 72, and 74, each having first and second inputs (A, B) and first and second outputs (C, D) series connected at first inputs/outputs to the output 62a. A fourth cross switch 76 has its first and second outputs coupled to outputs series connected to the input 62e and cross switch 80 has its second output coupled to the output 62f. A seventh cross switch 82 has its first and second outputs coupled to outputs 62g and 62i, respectively. The input 60h is connected is connected to the second input (B) of the cross switch 70, whose second output (O) is connected to the first input (A) of cross switch 78. The input 60c is coupled via a straight switch 90 to the second input (B) of cross switch 72, whose second output (D) is connected to the first output (A) of cross switch 76. The input 60d is coupled via a straight switch 92 to the second input (B) of cross switch 78, whose second output (D) of cross switch 82. The input 60e is coupled via straight switches 94 and 96 to the second input (B) of cross switch 74 whose second output (D) is connected to the output 62b. The input 60f is coupled via the straight switches 98 and 100 to the second input (B) of cross switch 76. The input 60h is coupled via the straight switches 102 and 104 to the second input (B) of cross switch 80. The input 60i is coupled via the straight switches 106 and 108 to the second input (B) of cross switch 82.

The 8-way distribution switch is constructed with two 4-way distribution switches, whose T1 ports are passed through the cross-switch XS30(70) to obtain the T1(60a) and T2(60b) ports for the 8-way distribution switch. The other three T ports in each of the 4-way switches are passed through straight-switches to obtain the T3 . . . T8 ports for the 8-way switch. Using the same rule, two 8-way switches can construct a 16-way distribution switch (N=4) and so on.

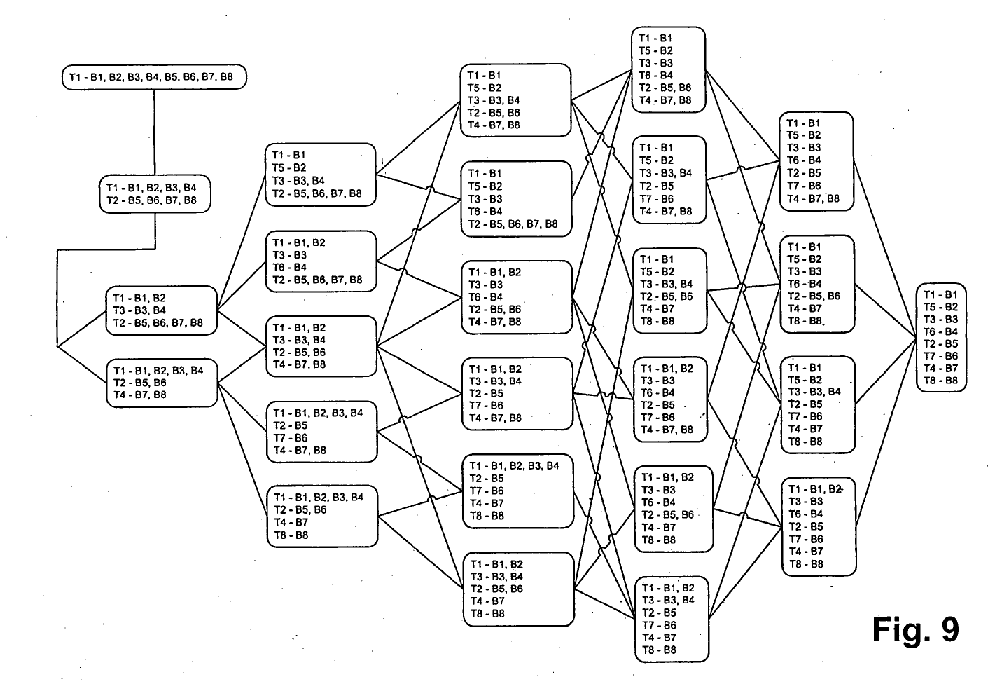

Referring to FIG. 9 there is illustrated the upgrade-downgrade paths for the 8-way distribution switch of FIG. 8. The switch can connect any number of transceivers between 1 and 8 (60a-60i). The service provider has the option of upgrading the system only when needed. If a transceiver is overloaded and covers two or more beams, its payload can always be split with a newly added transceiver. Both the upgrades and the downgrades do not require system shutdown and can be performed without any interruption of the ongoing communications.

When using more than one transceiver, if one transceiver fails, the switch can be reconfigured such that all beams are covered.

Similarly a 2^{N}-way distribution switch can be built that allows transceivers T1, T2 to cover 1, 2, 4, . . . , 2^{N} beams, transceivers T3, T4 to cover 1, 2, . . . , 2^{N-1} , T5, T6, T7, T8 to cover 1, 2, . . . , 2^{N-2} and so on. The fail-safe feature comes from the fact that for each sub-tree there are two transceivers that can cover the entire sub-tree.

Based on the structure of the switch, the number of beams that a particular transceiver covers in any configuration is always a power of 2. This helps with the development of the algorithms that will reside in each transceiver and will ensure coverage of the required number of beams.

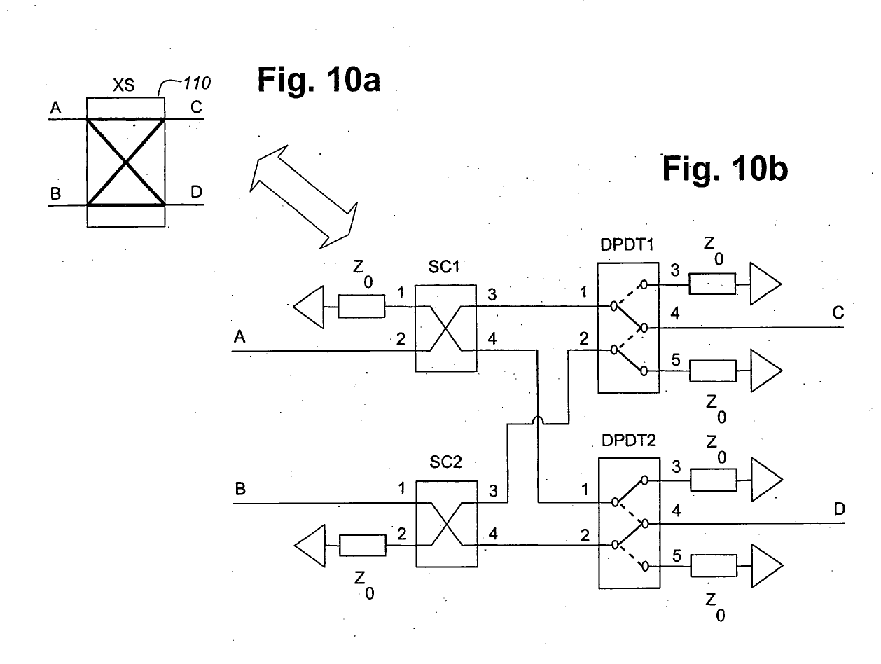

FIG. 10 shows a possible implementation of the cross-switch with two 5-terminal dual-pole-dual-terminal (DPDT) RF/IF switches: DPDT1 and DPDT2, and two 3 dB splitters/combiners made by SC1, SC2 and two termination impedances Z₀. The operation of the cross-switch is described in Table.

TABLE B
Cross-switch operation

| | | Cross- |
|---|---|---|
| DPDT1 | DPDT2 | switch |
| Connections | Connections | Made |
| 1-4, 2-5 | 1-3, 2-4 | Straight |
| 1-3, 2-4 | 1-4, 2-5 | Cross |
| 1-4, 2-5 | 1-4, 2-5 | A-only |
| 1-3, 2-4 | 1-3, 2-4 | B-only |

Note that, if same power level P [dB] is applied to ports A and B, then the power delivered at ports C and D under all configurations is P−3 dB (minus some negligible loss due to circuit imperfections). Therefore, the distribution switch will deliver the same power to each active beam, which means that the antenna system will deliver constant EIRP regardless of configuration of the distribution switch.

Note that insertion loss in the receive direction from either C or D to either A or B is constant (3 dB plus loss due imperfections) as long as the path is active. This means that the receiver sensitivity is constant regardless of configuration of the distribution switch.

Depending on the performance of the straight-switches in terms of insertion-loss and isolation, the straight-switch can be:
1. a simple 3 dB attenuator (switch is always closed)
2. a 3 dB attenuator series with an single-pole-single-terminal (SPST) RF/IF switch with no impedance matching
3. a 3 dB attenuator series with an SPST RF/IF switch with impedance matching.

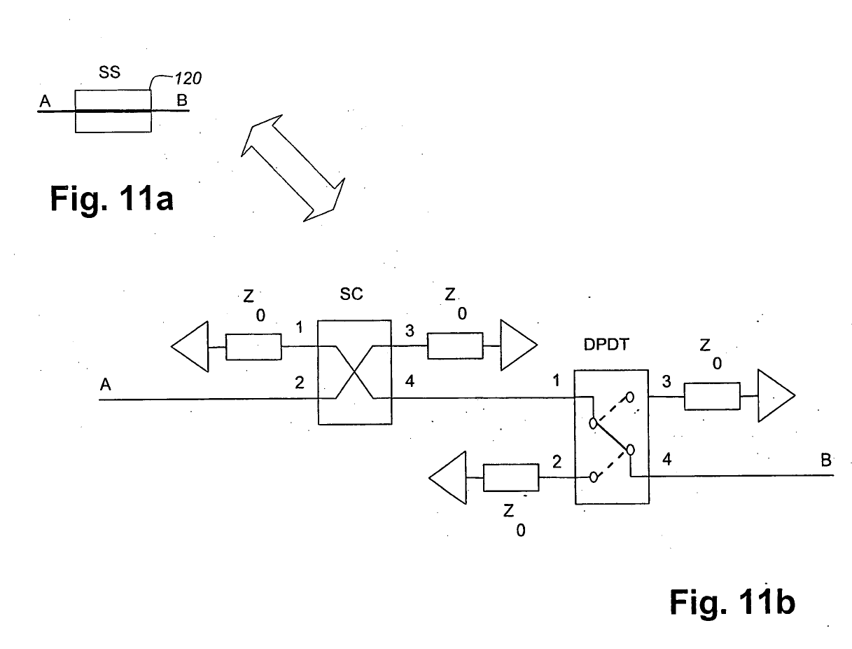

FIG. 11 shows a possible implementation of the straight-switch 120 as an SPST switch with impedance matching. The implementation uses a 4-terminal DPDT RF/IF switch as switching element. With the DPDT switch, if terminal 1 is connected to 4, then the straight-switch is closed (ports A and B are connected); if terminal 1 connects to 3 and terminal 2 to 4, then ports A and B are disconnected and each of them is terminated to ground with Z₀ (e.g. 50Ω). A 3 dB splitter/combiner is placed in series with the DPDT switch. This can be replaced by a simple 3 dB attenuator. To obtain an SPST switch without impedance matching, the two termination impedances Z₀ connected to the switch are removed from the circuit and the DPDT switch is replaced by a simple SPDT switch (placed between terminals 1 and 4).

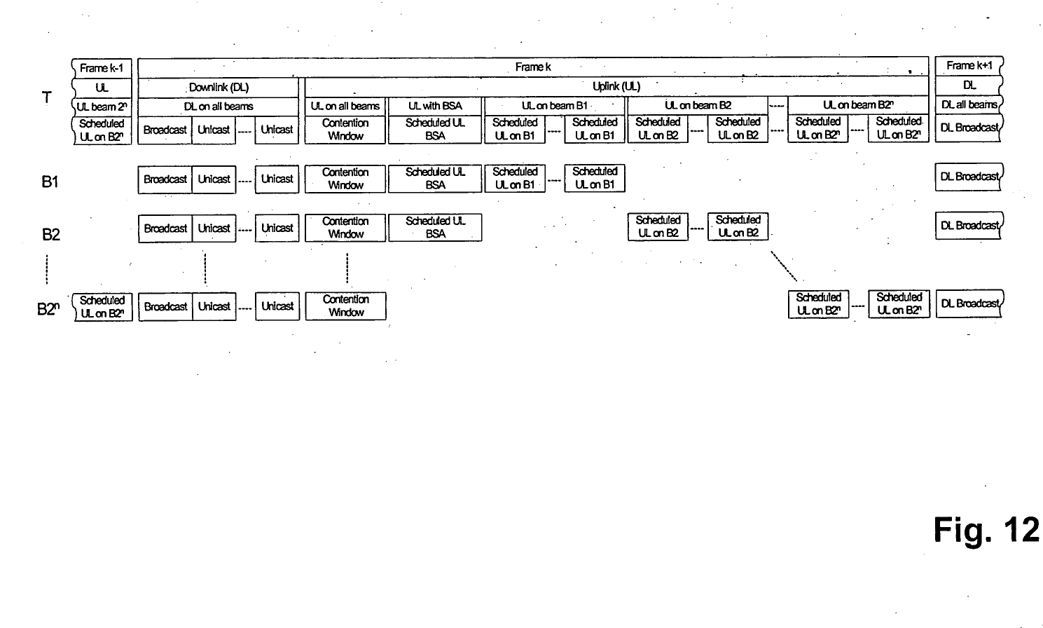

Referring to FIG. 12 there is illustrated the protocol for one MAC frame for TDM/TDMA access to 2ⁿ beams. In order to cover 2ⁿ beams: B1, B2, . . . ,B2ⁿ, a transceiver T accesses the beams using a combination of time-division-multiplexing (TDM) and time-division-multiple-access (TDMA). The following statements describe the operation with TDM/TDMA in detail. Both broadcast and unicast parts of the downlink are transmitted on all beams at the same time. Note that there is no overlap between beams and thus the beam gain and the beam shape are preserved on all beams. The information for different beams is multiplexed in time using TDM.

On the uplink, during contention windows, T receives signals from all beams. Again, since beams do not overlap, the beam gain and the beam shape are preserved on all beams. This permits new subscriber stations (SS) to register into the system and/or permits registered SSs to request bandwidth (as provided by some standards).

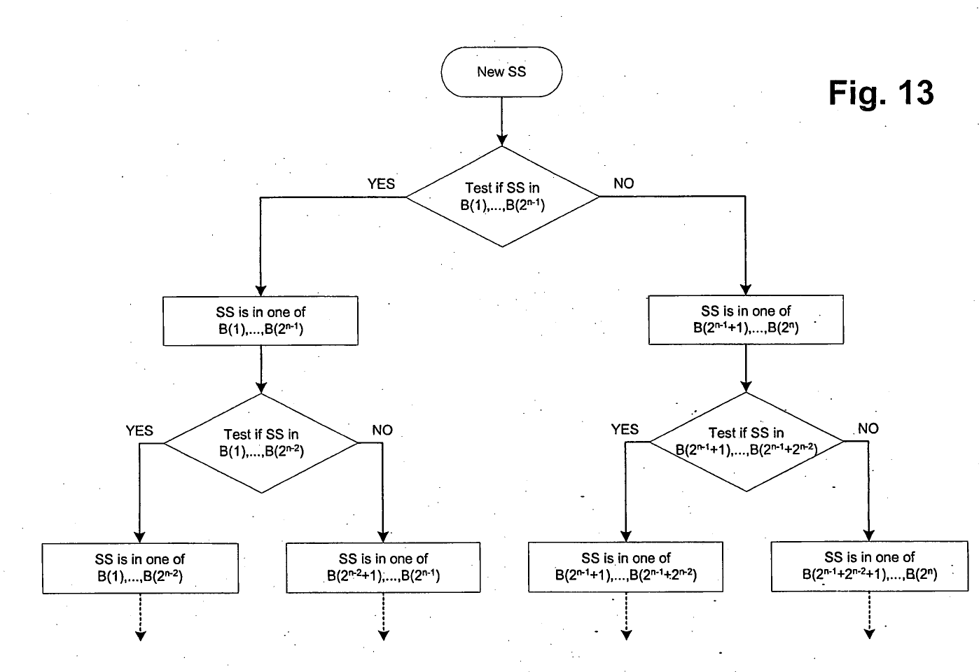

Referring to FIG. 13, there is illustrated in a flow chart a beam selection in accordance with an embodiment of the present invention. After initial registration in the contention window, during the subsequent n-frames, the SS will be polled n−1 times in the beam-selection-algorithm (BSA) part of the uplink. The polling in BSA is used by the transceiver in the BS to discover the beam it shall use to communicate with the new SS. During the first polling the transceiver T turns off 2ⁿ⁻¹ beams and receives the combined signal from the other 2ⁿ⁻¹ beams. With either successful or unsuccessful reception, the BS will know which group of 2ⁿ⁻¹ beams the SS belongs. During the next polling the BS turns off 2ⁿ⁻² of the 2ⁿ⁻¹ beams and so on.

For all registered stations with known location (beam), the BS receives the uplink by steering the beam to desired direction. This to minimize the interference at the receiver input. Thus, the information pertaining to different beams is multiplexed in a TDMA fashion on the uplink. Note that it not necessary to group the uplink bursts by beam. The system will have the same performance if the uplink bursts are not grouped by beam. The same applies to the downlink since the entire downlink is broadcasted to all beams.

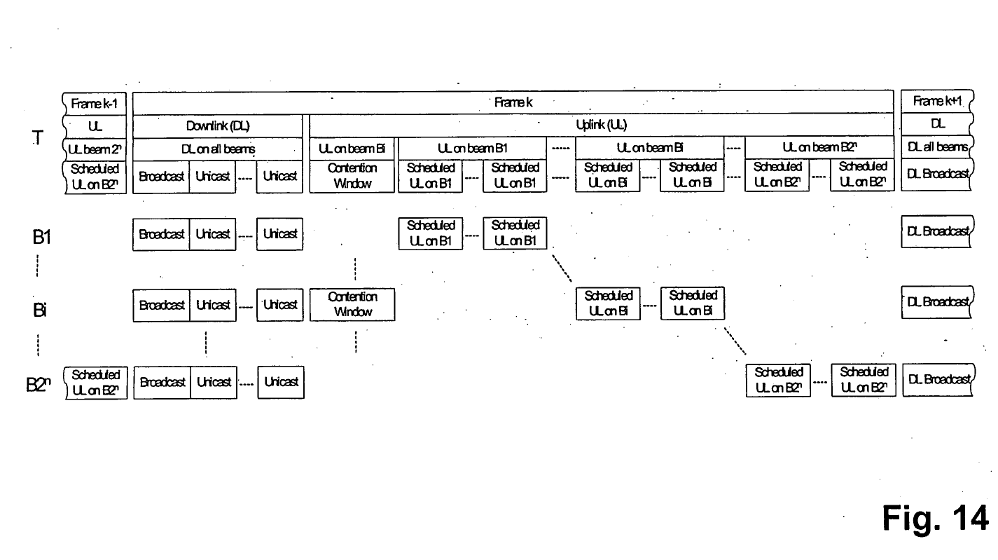

An alternate access method that does not require the use of BSA is shown in FIG. 14. The beams are multiplexed using TDM on the downlink and TDMA on the uplink, as in the previous solution. However, in order to discover the beam for a new SS, the registration contention window is active on single beam Bi at a time. Bi is changed every MAC frame such that all beams are covered in 2ⁿ MAC frames. This method simplifies the control of the distribution switch but may introduce significant delays during initial registration of a new SS if 2ⁿ is large.

1. A method of beam steering in a wireless network comprising the steps of:
generating a first plurality of signals, each of the first plurality of signals including a second plurality of signals, each signal compatible with time division multiple access and time division multiplexing;
distributing the first plurality of signals to a corresponding first plurality of antennas; and
passively forming a second plurality of beams.

2. A method as claimed in claim 1 wherein each first plurality is M, where M is an integer.

3. A method as claimed in claim 2 wherein the second plurality is 2^{N}, where N is an integer.

4. A method of beam steering in a wireless network comprising the steps of:
generating a first plurality of signals, each of the first plurality of signals including a second plurality of signals, each signal compatible with time division multiple access and time division multiplexing;
distributing the first plurality of signals to a corresponding first plurality of antennas; and
passively steering a second plurality of beams.

5. A method as claimed in claim 4 wherein each first plurality is M, where M is an integer.

6. Apparatus for beam steering in a wireless network comprising:
means for generating a first plurality of signals, each of the first plurality of signals including a second plurality of signals, each signal compatible with time division multiple access and time division multiplexing;
means for distributing the first plurality of signals to a corresponding first plurality of antennas; and
means for passively forming a second plurality of beams.

7. Apparatus as claimed in claim 6 wherein each first plurality is M, where M is an integer.

8. Apparatus as claimed in claim 7 wherein the second plurality is 2^{N}, where N is an integer.

9. Apparatus for beam steering in a wireless network comprising:
means for generating a first plurality of signals, each of the first plurality of signals including a second plurality of signals, each signal compatible with time division multiple access;
means for distributing the first plurality of signals to a corresponding first plurality of antennas; and
means for passively steering a second plurality of beams.

10. Apparatus as claimed in claim 9 wherein each first plurality is M, where M is an integer.

11. Apparatus as claimed in claim 10 wherein the second plurality is 2^{N}, where N is an integer.
